(19) United States
(12) Patent Application Publication
(10) Pub. No.: US 2007/0124866 A1
(43) Pub. Date: Jun. 7, 2007

(54) VERTICALLY STANDING STAPLER AND TAPE DISPENSING DEVICE

(76) Inventor: RYAN GREPPER, LA JOLLA, CA (US)

Correspondence Address: QUICKPATENTS, INC., 31877 DEL OBISPO, SUITE 202, SAN JUAN CAPISTRANO, CA, 92675, US

(21) Appl. No.: 11/567,171

(22) Filed: Dec. 5, 2006

Related U.S. Application Data
(60) Provisional application No. 60/742,688, filed on Dec. 6, 2005.

(51) Int. Cl. B25C 5/02

(52) U.S. Cl. 7/160; 227/156

(57) ABSTRACT

A combination stapler and tape dispenser device is disclosed that may be oriented on a desk either vertically or horizontally. The inventive device includes a tape dispenser, a functioning stapler, and a body housing both. The housing body is shaped to contain the stapler at a posterior end and the tape dispenser on the opposite anterior end such that the device may be stored and used in a traditional horizontal position, as well as stored vertically to save space. The housing includes both a top and bottom handle that are pivotably joined by a hinge shaft. The stapler comprises all of the functional parts typically found in an office stapler including, but not limited to, a stapler arm, a staple housing, staples, a staple driving mechanism, an anvil designed to close each staple, a hinge shaft for pivotably joining the stapler housing with the top handle, a device to advance the staples, and a spring or similar device to maintain position of stapler arm. The tape dispenser comprises a replaceable roll of tape, a serrated edge to cut and retain the dispensed tape thereon, a tape-roll-holder upon which said tape roll is placed and held securely as the tape roll holder dispenses the tape.

### CROSS-REFERENCE TO RELATED APPLICATIONS

This application claims the benefit of U.S. Provisional Patent Application 60/742,688, filed on Dec. 6, 2005.

### STATEMENT REGARDING FEDERALLY SPONSORED RESEARCH AND DEVELOPMENT

Not applicable.

### BACKGROUND OF THE INVENTION

1. Field of the Invention

The present invention relates generally to staplers and tape dispensers and, more specifically, it relates to a vertically standing combination stapler and tape dispenser device.

2.Description of the Related Art

It can be appreciated that staplers and tape dispensers have been in use for years. Typically, staplers have comprised hand-held and desktop-type staplers, and tape dispensers have comprised disposable and desktop-type tape dispensers.

While these devices may be suitable for the particular purpose to which they address, they are not suitable for allowing a person to use one device for both stapling and tape dispensing needs. The main problem with conventional staplers and tape dispensers is that both of these common office tools occupy considerable desktop space in light of the frequency of their use. While some staplers now can be stored in a vertical orientation, such as that taught in U.S. Pat. No. 6,152,347 to Wilson on Nov. 28, 2000, desktop tape dispensers are typically bulky, heavy, and not easily portable. Another problem with conventional staplers and tape dispensers is that they perform only one task. It is believed that people who store their tape dispensers and staplers on a desktop would benefit from a space saving product that performs both as a stapler and a tape dispenser.

Another problem with conventional staplers and tape dispensers is that portable tape dispensers are typically disposable and, as such, are prone to easily breaking if carried with other objects or mishandled. Disposable tape dispensers are intrinsically wasteful as the entire dispenser is discarded when the tape roll has been used up.

There are several devices that combine various desktop implements, such as U.S. Pat. No. 4,727,610 to Lin on Mar. 1, 1988, which teaches a tape dispenser integrated with a stapler. However, such devices still require a significant amount of desktop space. Further, such devices are somewhat cumbersome and awkward to use, as they combine many additional features beyond a stapler and tape dispenser, such as storage bins and hole punches, rendering it expensive to manufacture and expensive to purchase. Further this device is not designed to be stored in a vertical orientation and if positioned vertically, would be poorly balanced as the tape dispenser is positioned on the staple-tray side on the top handle. Still further, this device teaches a cover over the tape dispenser which inhibits quickly dispensing a piece of tape.

In these respects, the vertically standing stapler and tape dispenser device according to the present invention substantially departs from the conventional concepts and designs of the prior art, and in so doing provides an apparatus primarily developed for the purpose of allowing a person to use one vertically stored device for most stapling and tape dispensing needs, thus saving space and creating efficiency. Further, such a needed device is easy and intuitive to use. Still further, such a needed device is relatively inexpensive to manufacture, as a vertically standing device does not have to be weighed down with additional weights to prevent the unit from sliding across a desk when pulling tape loose from the tape role, as frequently happens with light-weight desktop tape dispensers.

### SUMMARY OF THE INVENTION

In view of the foregoing disadvantages inherent in the known types of staplers and tape dispensers in the prior art, the present invention provides a new vertically standing combination stapler and tape dispenser device wherein the same can be utilized for allowing a person to use one device for most stapling and tape dispensing needs, thus saving desktop space and creating efficiency.

The general purpose of the present invention, which will be described subsequently in greater detail, is to provide a new vertically standing combination stapler and tape dispenser device that has many of the advantages of the stapler and tape dispenser devices mentioned heretofore and several novel features that result in a new vertically standing stapler and tape dispenser device which is not anticipated, rendered obvious, suggested, or even implied by any of the prior art stapler and tape dispenser, either alone or in any combination thereof.

To attain this, the present invention generally comprises a tape dispenser, a functioning stapler, and a body that houses both. The housing body is shaped to contain a stapler on a posterior end and a recessed opening and general shape to house the tape dispenser on the opposite anterior end in such a way as to be able to be stored and used in a traditional horizontal or handheld position, as well as stored vertically to save space. The stapler comprises all the functional parts typically found in an office stapler including, but not limited to, a stapler arm, a staple housing, staples, a staple driving mechanism, an anvil designed to close the staple around a plurality of sheets of paper through which the a staple has been driven, pivots for allowing the stapler and housing body to articulate, a spring-biased device to advance the staples towards the staple driving mechanism, and springs or similar biasing devices to maintain a raised position of stapler arm above the anvil. The tape dispenser comprises a replaceable roll of, preferably, but not limited to, cellophane tape, a serrated edge to cut and retain dispensed tape thereon, a tape roll holder upon which said tape roll is placed and held rotationally as the tape roll holder spins to dispense tape.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a vertically standing stapler and tape dispenser device that will overcome the shortcomings of the prior art devices.

An object of the present invention is to provide a vertically standing stapler and tape dispenser device for allowing a person to use one device for most stapling and tape dispensing needs, thus saving space and creating efficiency.

Another object is to provide a vertically standing stapler and tape dispenser device that functions conveniently as both a tape dispenser and stapler.

Another object is to provide a vertically standing stapler and tape dispenser device that can be stored in a vertical orientation to maintain a small footprint on a desktop surface.

Another object is to provide a vertically standing stapler and tape dispenser device that can function in a traditional horizontal position if desired.

Another object is to provide a vertically standing stapler and tape dispenser device that can be easily and intuitively operated in a hand-held manner.

Another object is to provide a vertically standing stapler and tape dispenser device that is portable and refillable.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a perspective view of the present invention, illustrating a stapler thereof.

FIG.2 is a perspective view of the present invention, illustrating a tape dispenser thereof.

FIG.3 is a left side elevational view of the present invention, illustrating the invention as standing vertically on a surface.

FIG.4 is an alternate left side elevational view of the invention, illustrating the invention standing vertically and rotated 180 degrees from the invention as shown in FIG. 3.

FIG.5 is a bottom plan view of the present invention, illustrating the tape dispenser of the invention.

FIG.6 is a top plan view of the present invention.

FIG.7 is a front elevational view of the present invention, illustrating the stapler thereof.

FIG.8 is a rear elevational view of the present invention, illustrating the tape dispenser thereof.

FIG.9 is a perspective view of the present invention, illustrating a stapler housing in an open position for loading staplers therein; and.

FIG. 10 is a partial wire-frame view of the present invention showing additional features of the tape dispenser thereof.

### DETAILED DESCRIPTION OF THE INVENTION

Turning now descriptively to the drawings, in which similar reference characters denote similar elements throughout the several views, the attached figures illustrate a vertically standing combination stapler and tape dispenser device, which comprises a tape dispenser 2, a functioning stapler 1, and a body 5 housing both therein.

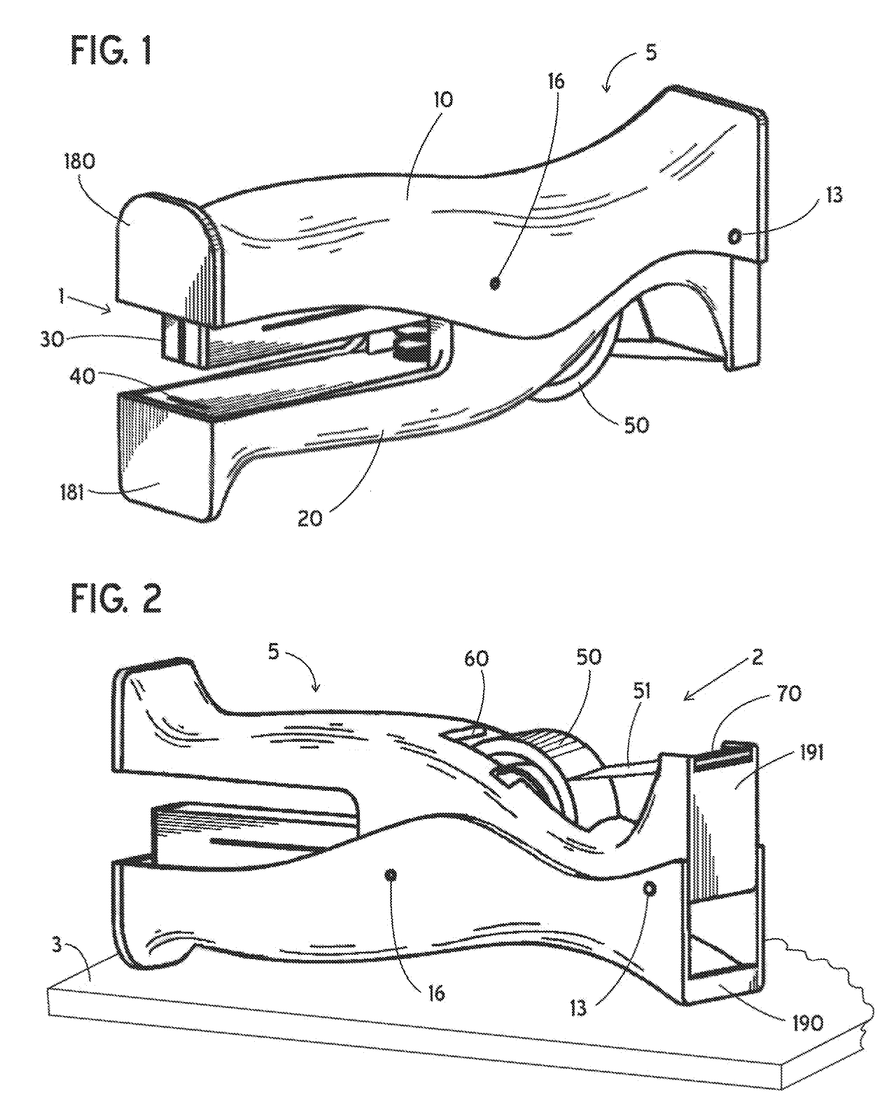

The housing body 5 is shaped to contain a stapler 1 on a posterior end 180 and the tape dispenser 2 on an opposite anterior end 190 in such a manner as to be able to be stored and used in a traditional horizontal or handheld position, as well as stored vertically to save space (FIGS. 3 & 4). The housing body 5 (FIGS. 1 & 2) comprises a top handle 10 and a bottom handle 20 designed to contain both a conventional stapler 1 and a tape dispenser 2, storable vertically or horizontally on either end 180, 190, and to enable the present invention to be operable in both a desktop and hand-held position.

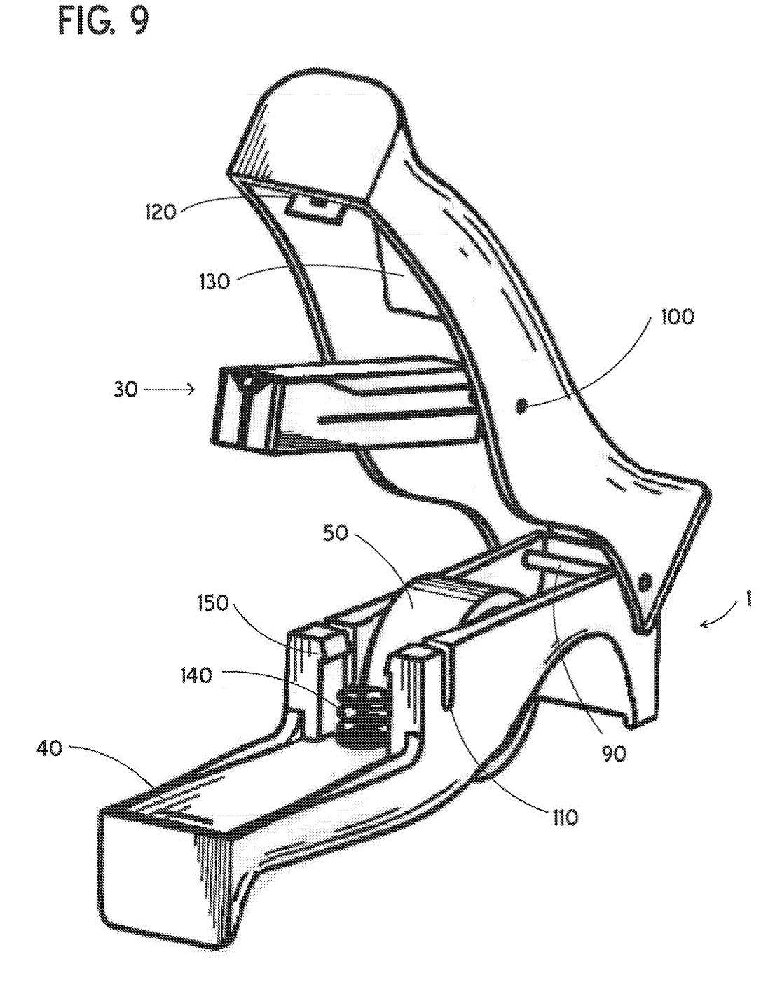

FIGS. 1 and 9 show the present invention, comprising both the top handle 10 and the bottom handle 20, each having apertures 13 for insertion of a hinge pin 90 therein for pivotably retaining the top and bottom handles 10, 20 together. The top handle 10 and bottom handle 20 are generally contoured to conform to a user's hand (not shown). FIGS. 1 and 2 show both the top handle 10 and the bottom handle 20 are shaped to allow the present invention to be both operated and stored horizontally, such as on a flat horizontal surface 2, or vertically (FIGS. 3 & 4).

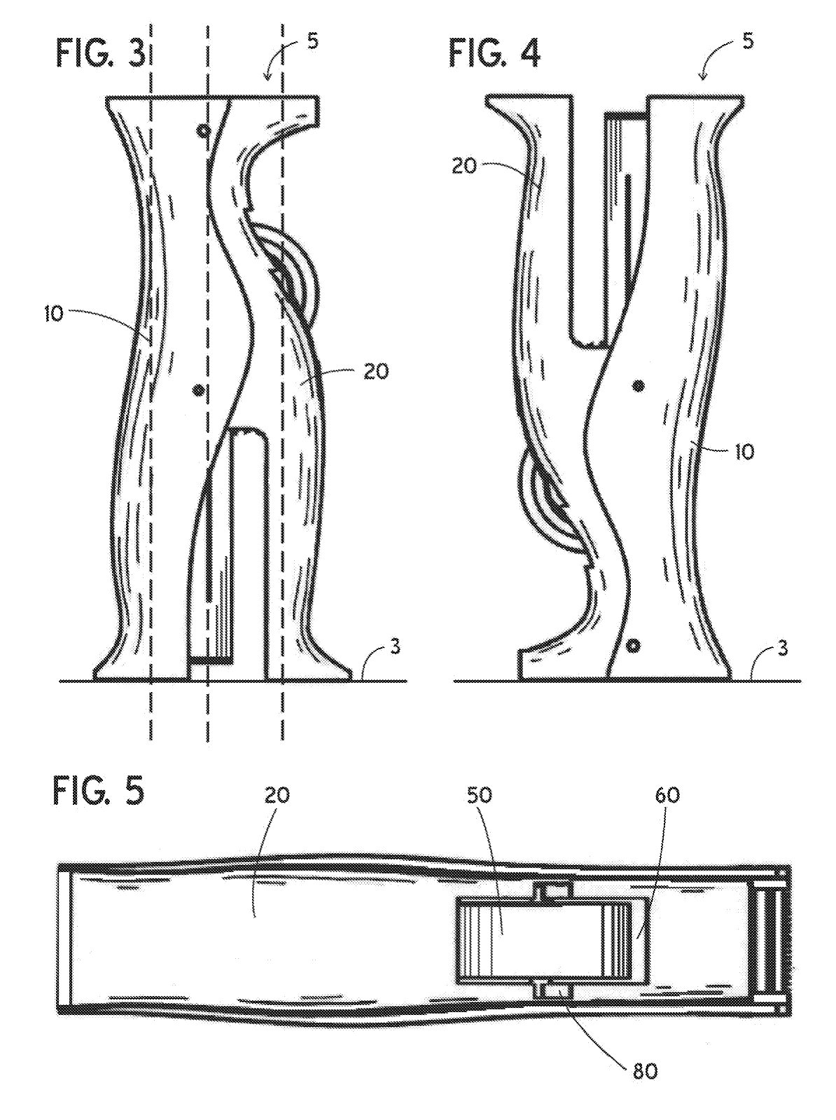

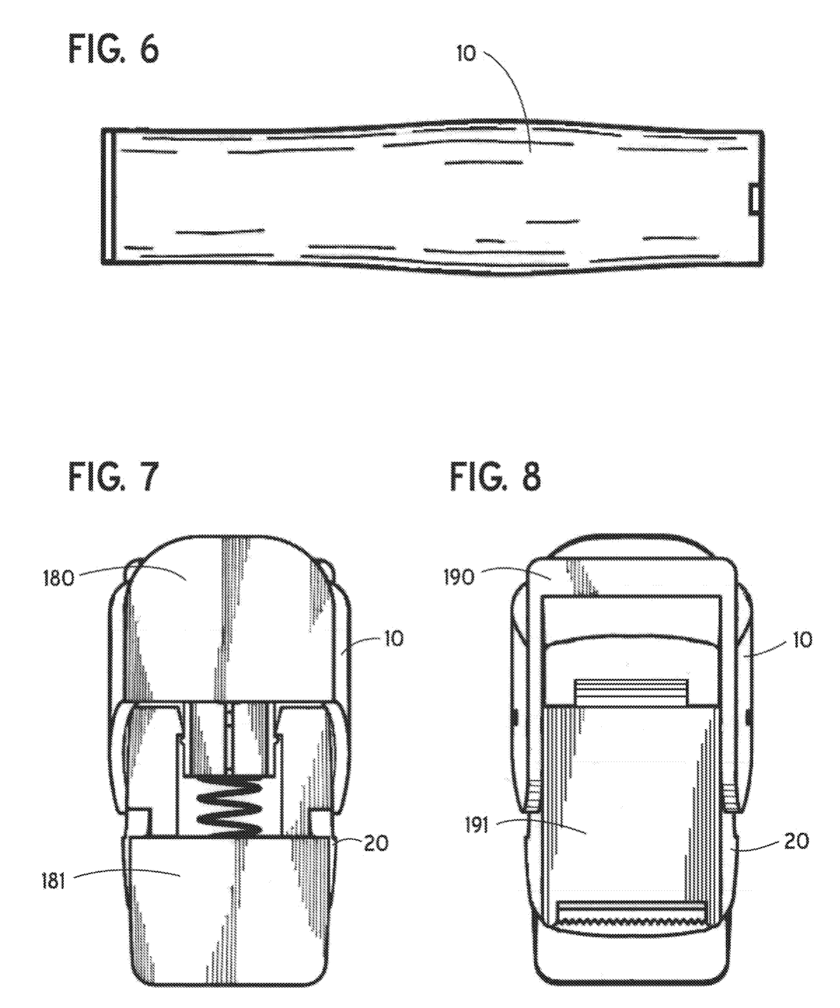

A stapler mechanism 30 is fixed between the top handle 10 and the bottom handle 20 by means of a hinge shaft or pin 100 inserted through apertures 16 in the top handle 10 and bottom handle 20, respectively. FIG. 2 shows a recessed opening 60 in the bottom handle 20 wherein a roll of tape 50 is rotationally retained opposite the stapler 1. This unique feature allows for balancing of the device when stored in a vertical orientation as shown in FIGS. 3 and 4. FIGS. 7 and 8 illustrate how end portions 180,181 and 190,191 of the top handle 10 and bottom handle 20 are formed as blunt, flat ends which allow the present invention to be stored in said vertical orientations on the flat, horizontal surface 3. Storing the present invention in this position reduces the total area of storage space necessary on a user's desk or tabletop, for example, particularly as compared with the space necessary to accommodate a traditional stapler and a tape dispenser (not shown). Additionally, with the present invention stored in either vertical orientation (FIG. 3 & 4) it is easier for the user to locate, to grab a hold of, and use quickly. The housing body 5 is preferably made of ABS plastic, urethane, or any other suitably rigid plastic, or plastic like, material. The housing body 5 may also be made of metal, cast metal, wood, rubber, or similar rigid materials to give the desired surface finish, texture, weight or appearance.

The stapler 1 comprises all the functional parts typically found in an office stapler, including, but not limited to: a stapler arm, which in the present case is a portion of the top handle 10, a staple housing 30, staples (not shown), a staple driving mechanism 120, a staple bending device such as an anvil 40 designed to close the staple around a plurality of sheets (not shown) through which a staple has been driven by the staple driving mechanism 120, a hinge shaft 100 that pivotably connects the staple housing 30 to the top handle 10, a biasing device to advance the staples in the staple housing towards the staple driving mechanism 120 (not shown), and springs 130,140 or similar biasing devices to, after use, urge the handles 10,20 and the staple housing 30 to return to a raised position with respect to the anvil 40.

FIG. 9 shows a perspective view of the stapler 1 of the present device. The staple housing 30 is pivotably attached to the top handle 10 by means of a hinge shaft 100, preferably a pin, such that the staple housing 30 does not interfere with the position of the tape roll 50 when the top handle 10 is in a closed position (as illustrated in FIGS. 3 and 4). The staple housing 30 includes the standard features known to a person skilled in the art, such as, staples (not shown), a device to hold the staples in position (not shown), and a device to advance the next staple to be used (not shown). The staples are driven from the staple housing 30 when a downward force is applied to the top handle 10 causing the upper biasing device 130, preferably an upper spring 130 or spring steel bar, to compress. This allows the staple housing 30 to pivot and the staple driver 120 to pass through the staple housing 30 to push one staple forcefully out from the staple housing 30, typically passing through a plurality of paper sheets (not shown), and compressing against the anvil 40. The anvil 40 preferably includes indentations (not shown) aligned with legs of the exiting staple and shaped to force the staple legs to bend around said sheets of paper, as is known in the art.

In the preferred embodiment of the present invention the lower handle 20 has a cutout 110 to allow the hinge shaft 100 to pass by unobstructed. The stapler housing 30 and top handle 10 are returned to a resting position, illustrated in FIG. 1, by the lower biasing device 140, preferably a spring 140 or spring steel flexible bar, and retained in position frictionally by a retaining notch 150 of the bottom handle 20. The staple housing 30 can be accessed for refilling the staple housing 30 with staples by applying an upward force to the top handle 10 to overcome the friction generated by the retaining notch 150, thereby allowing the top handle 10 and bottom handle 20 to pivot apart as shown in FIG. 9. The stapler 1 is ideally made of metal or a suitable material with desired properties, and other than its total length and specific positioning to facilitate overall function of the present invention, should be considered obvious to someone skilled in the art.

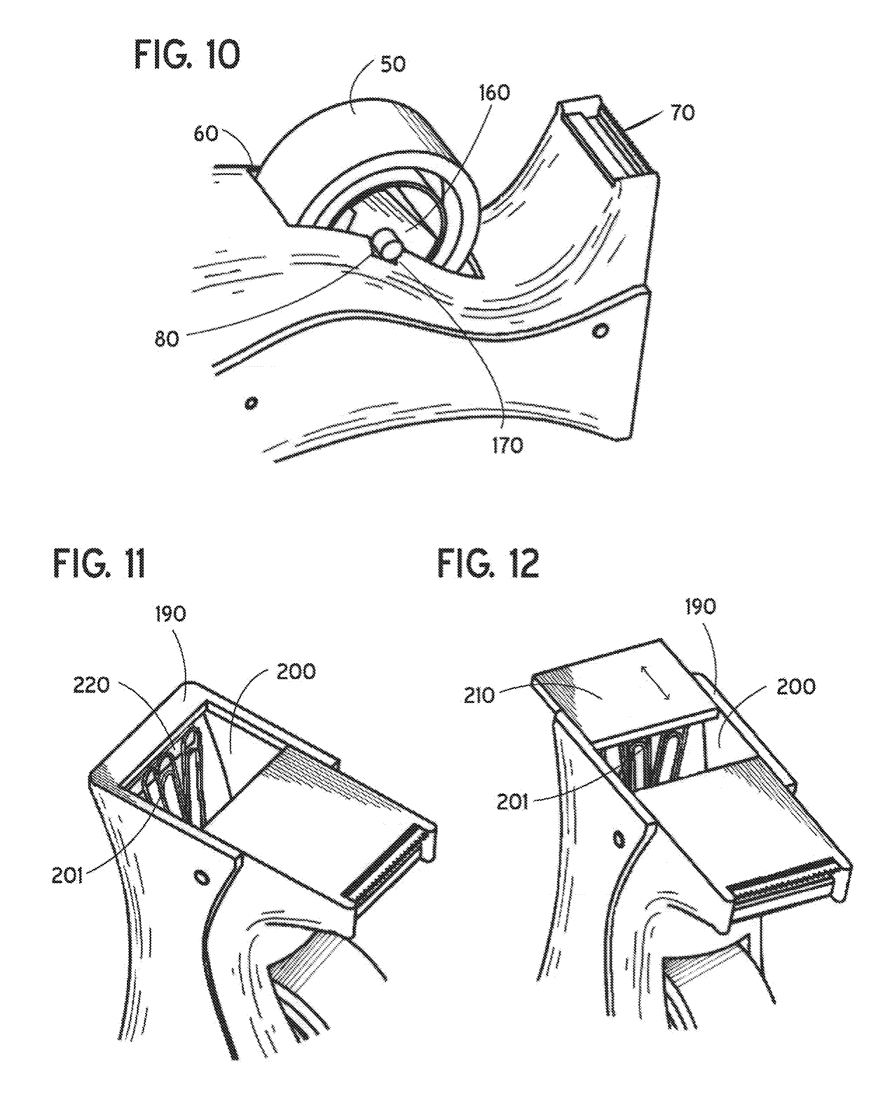

The tape dispenser 2 comprises: a replaceable roll of, preferably, but not limited to, cellophane tape 50, a serrated edge 70 to cut dispensed tape 50, a tape-roll-holder 160 upon which said tape roll 50 is placed and held securely as tape-roll-holder 160 spins to dispense tape 50. The tape dispenser 2, as shown in FIG. 10, comprises the refillable roll of tape 50 frictionally positioned concentrically on the generally cylindrical tape roll-holder 160. The tape roll-holder 160 is fixed in the bottom handle 20 in a recessed opening 60 at a tape roll-holder guide 80, and is frictionally retained thereby or, in the preferred embodiment, by a tape roll-holder retaining means 170, such as a retaining notch 170. The tape role holder 160 may also be frictionally retained by tensioned tape 51 (FIG. 2), or the shape of the tape roll-holder guide 80 itself (FIG. 5). The serrated edge 70 of the tape dispenser 2 also frictionally retains the adhesive end of the tape roll 50 for easy grasping in use. The tape dispenser 2 typically holds a standard roll of cellophane tape, but can also be designed to hold any other type of tape such as, but not limited to; electrical tape, masking tape, and the like. In the preferred embodiment of the present invention, the tape cutter 70 is metal, but can also be any other suitable material such as plastic, or it can be integrally molded into the bottom handle 20.

Preferably, the combination stapler and tape dispenser device of the present invention may further include a paper clip holder (FIG. 11) formed proximate the anterior side 190 of the top handle 10, the top handle 10 further including a paper clip aperture for accessing the paper clip holder 200, as is known in the art. An optional spring-biased cover 210 (FIG. 12) for normally covering the aperture may further be included. Alternately, the aperture may include at least one magnet 220 for retaining paper clips 201 thereon and preventing paper clips 201 from falling out of the paper clip holder 200. Further, a stapler remover mechanism (not shown) may be fixed proximate the anterior side 190 of the top handle 10, or to the posterior side 181 of the bottom handle 20.

The present invention can be scaled to any practical size depending on use, and specifically can utilize a relatively small stapler mechanism 1 and a relatively small tape roll 50 for even greater portability.

The present invention functions as a combination stapler and tape dispenser, and is designed to replace both of these prior-art stand-alone devices. As described, the present invention is a significant improvement over the prior art, as the present invention synergistically combines the functions of a handheld or desktop stapler with a tape dispenser such that both devices are improved. Specifically:

(a) the present invention uses significantly less desktop area than both a standard desktop stapler and tape dispenser do separately when the present device is stored vertically on a desk top.

(b) the present invention uses less space than both standard devices separately when stored horizontally on a desk top.

(c) when stored vertically, the present invention allows for quick access to either tape or stapling functions.

(d) the present device improves desktop efficiency as the user now is only searching for one device for two of the most common office device needs.

(e) the offset placement of the tape roll from the stapler mechanism allows for optimal balancing of the present invention in a vertical orientation by maintaining the center-of-gravity close to a vertical axis of the device, a function that is not contemplated in prior art.

As to a further discussion of the manner of usage and operation of the present invention, the same is apparent from the above description. Accordingly, no further discussion relating to the manner of usage and operation needs to be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A combination stapler and tape dispenser, comprising:
a housing body that includes an elongated top handle and an elongated bottom handle, the top handle and bottom handle each having both posterior and anterior sides, the top handle and bottom handle each pivotably joined together proximate their anterior sides, the posterior and anterior sides of both the top and bottom handles being substantially flat,
a stapler mechanism mounted proximate to the posterior sides of the top and bottom handles, the stapler mechanism including a staple housing pivotally fixed at one end thereof to the bottom handle, a staple driving mechanism fixed proximate the posterior side of the bottom handle, an anvil fixed proximate the posterior side of the top handle, a staple advancing means within the staple housing, and a biasing means fixed between the top and bottom handles for urging the stapler arm away from the anvil, and
a tape dispenser formed proximate the anterior side of the bottom handle, the tape dispenser including a tape roll holder for holding a role of tape, a serrated edge fixed proximate the anterior side of the bottom handle for cutting the tape, and a tape roll holder guide formed in the bottom handle for securing the tape role holder thereto;
whereby the combination may be rested upon a surface on the posterior sides of the handles, the anterior sides of the handles, on the top handle, or on the bottom handle, without tipping, the center of gravity of the combination being proximate a longitudinal axis thereof.

2. The combination stapler and tape dispenser of claim 1 wherein the biasing means is a lower spring contacting on a bottom end thereof the bottom handle, and contacting on a top end thereof a hinge shaft of the stapler mechanism, the hinge shaft fixed between apertures of the bottom handle and pivotally fixing the stapler arm thereto, whereby the lower spring urges the bottom handle away from the hinge shaft.

3. The combination stapler and tape dispenser of claim 1 wherein the biasing means further includes an upper spring fixed between the top handle and the staple housing, whereby the spring urges the top handle away from the staple housing.

4. The combination stapler and tape dispenser of claim 1 wherein the bottom handle includes a retaining notch that cooperates with the staple housing in the top handle for retaining longitudinal axes of the top and bottom handles, and the staple housing, in a generally parallel orientation.

5. The combination stapler and tape dispenser of claim 1 wherein the guide formed in the bottom handle for securing the tape role holder includes a tape roll holder retaining means for securing the tape role holder therein.

6. The combination stapler and tape dispenser of claim 5 wherein the tape roll holder retaining means is a retaining notch that provides a friction fit with the tape role holder.

7. The combination stapler and tape dispenser of claim 1 further including a paper clip holder formed proximate the anterior side of the top handle, the top handle including a paper clip aperture for accessing the paper clip holder.

8. The combination stapler and tape dispenser of claim 8 wherein the top handle further includes a paper clip aperture cover pivotally attached to the top handle at one side of the paper clip aperture and biased to cover the paper clip aperture, whereby the paper clip aperture cover may be manually urged away from the paper clip aperture to allow manual access to the paper clip holder.

9. The combination stapler and tape dispenser of claim 8 wherein the paper clip aperture further includes at least one magnet for retaining a paper clip thereon and preventing paper clips from falling out of the paper clip holder.

10. The combination stapler and tape dispenser of claim 1 wherein the top handle further includes a staple remover mechanism fixed proximate the anterior side thereof.

11. The combination stapler and tape dispenser of claim 1 wherein the bottom handle further includes a staple remover mechanism fixed proximate the posterior side thereof.
